(19) United States
(12) Patent Application Publication
(10) Pub. No.: US 2020/0290926 A1
(43) Pub. Date: Sep. 17, 2020

(54) PRODUCTION OF THERMAL ENERGY STORAGE SYSTEMS

(71) Applicant: THE EUROPEAN UNION, REPRESENTED BY THE EUROPEAN COMMISSION, Brussels (BE)

(72) Inventors: Marco Gianni Luigi LAMPERTI TORNAGHI, Cassano d'Adda (Milano) (IT); Alessio CAVERZAN, Milano (IT)

(73) Assignee: The European Union, Represented by the European Commission, Brussels (BE)

(21) Appl. No.: 16/630,280

(22) PCT Filed: Jul. 12, 2018
(86) PCT No.: PCT/EP2018/069020

§ 371 Date: Jan. 10, 2020

(30) Foreign Application Priority Data
Jul. 12, 2017 (EP) 17181062.5

(51) Int. Cl. C04B 20/10; C09K 5/06; C04B 18/02; C04B 14/12; C04B 28/02; E04B 1/76

(52) U.S. Cl. CPC C04B 20/1025; C09K 5/063; C04B 18/027; C04B 2103/0071; C04B 20/1029; C04B 28/02; E04B 1/76; C04B 14/12

(57) ABSTRACT

The invention relates to a method for producing thermal energy storage components comprising phase change material embedded into porous components, in particular for use in cement-based compositions. The method comprises: an impregnation step (10) comprising introducing phase change material into porous components inside a main vessel (102) by vacuum impregnation; an injection step (12) at a temperature within a melting temperature range of said phase change material and under an overpressure, in order vacuuming to force the phase change material into the porous components; and an entrapment step (14) comprising reducing the temperature inside the main vessel, while maintaining an the overpressure, in order to lower the viscosity of said phase change material.

### TECHNICAL FIELD

The present invention relates to the field of energy efficient building envelopes, in particular using thermal energy storage systems incorporating phase change material. The present invention particularly relates to a method for producing thermal energy storage porous components. More particularly, the invention concerns a method for producing porous aggregates carrying phase change material, for use in cement-based compositions.

### BACKGROUND OF THE INVENTION

The energy efficiency of buildings is today a prime objective for energy policy at regional, national and international levels. Thermal energy storage (TES) systems could be used to reduce buildings' dependency on fossil fuels, to contribute to a more environmentally efficient energy use and to supply heat reliably. The main advantage of using thermal storage is that it can contribute to match supply and demand when they do not coincide in time.

As it is known, an effective way to reduce the buildings' energy consumption for heating and cooling is by incorporating a phase change materials (hereinafter PCMs) in passive latent heat thermal energy storage systems of building's walls, windows, ceilings or floors. Such systems are said to be “passive” in the sense that the phase-change processes occur without resorting to mechanical equipment.

PCMs provide a large heat capacity over a limited temperature range and they could act like an almost isothermal reservoir of heat. PCMs, which can be organic or inorganic compounds, melt and solidify with a predetermined melting range suitable for a specific application. Using PCMs makes it possible to harvest latent thermal energy during a warm period of the day and to release this energy when the temperature goes below a predetermined threshold. The latter phenomenon is triggered by the change of phase of the material between a solid and a liquid phase. Accordingly, the choice of the PCM is mainly driven by its phase-transition temperature, in consideration of the daily temperature changes.

Once the PCM has been selected, its mode of incorporation into the passive thermal energy storage systems (construction materials or building elements) is to be determined. Various methods are known in the art to incorporate PCM amongst which: direct incorporation, immersion, encapsulation, shape-stabilization.

While direct incorporation and encapsulation, in particular micro-encapsulation are considered as the main routes of incorporation of PCM, an alternative approach consists in using porous aggregates as carrier for PCM.

For example, DE 19929861 A1 describes the incorporation of PCM into porous aggregates such as light-weight aggregates (LWA). The process involves soaking the porous aggregates in liquid PCM; it can be accelerated by increasing the temperature and operating under vacuum. The obtained components are then provided with a coating on their outer surface to prevent leakage of the PCM from the pores, e.g. using Teflon or natural materials, such as hydraulic binders.

EP 2308813 A1 discloses a vacuum impregnation procedure in an autoclave, to embed phase change material up to a certain depth in cellular concrete blocks.

More recently, the process of shape stabilization was also described by Marco Lamperti Tornaghi and Alessio Cavezan in their paper “Energy-efficient building envelopes: use of phase change materials in cement-based composites”, IABSE Conference—Structural engineering: Providing solutions to global challenges September 23-25 2015, Geneva, Switzerland. The main statement of the project E4iBuildings, the commonly used PCMs (paraffins derived from oil refinery) were compared to Bio-based PCMs, with the aim of using technical grade fatty acids and glycerol. Shape stabilization using porous light-weight aggregate as PCM carrier is considered as particularly interesting. Indeed, the authors consider that an LWA with an absorption capacity of about 70% by volume could embed at least 20% by volume of PCM, which means 100 to 150 kg/m³ of phase change material in a typical lightweight concrete. This is about ten times greater than the amount of phase change material embedded in a concrete with conventional microencapsulation.

Despite these promising statements, the paper does not describe any method of preparing such thermal energy storage aggregates (TESA). A mere reference is made to a two-step method, which basically consists in embedding PCMs in a carrier (LWA) and then making light-weight concrete using the LWA.

### OBJECT OF THE INVENTION

It is an object of the present invention to provide an improved method for producing porous light-weight aggregates, or generally porous components, that carry a great quantity of phase change material.

### GENERAL DESCRIPTION OF THE INVENTION

The present invention proposes a method for producing thermal energy storage components comprising phase change material embedded into porous components, in particular for use in cement-based compositions. The method comprises an impregnation step comprising introducing phase change material (PCM) into porous components inside a main vessel by vacuum impregnation.

According to the invention, the method further comprises:
an injection step at a temperature within a melting temperature range of the PCM and under an overpressure, in order to force the PCM into the porous components; and
an entrapment step comprising reducing the temperature inside the main vessel, while maintaining the overpressure, in order to lower the viscosity of the PCM.

The present invention provides an improved method for producing thermal energy storage (TES) components. The impregnation step is followed by the injection step and then by the entrapment step, which are designed to enhance absorption of PCM in the pores of the component. This is achieved by acting on pressure and temperature. The overpressure established during the injection step forces the liquid PCM into the pores; the temperature is advantageously controlled for an optimal fluidity. In the entrapment step, the overpressure is maintained while the operating temperature is reduced close to the meting point, in order to reduce the fluidity of the PCM while avoiding solidification: the PCM is thus trapped in the pores of the components but the surrounding PCM retains some fluidity to allow its separation.

The term “porous component” herein designates any solid product, article or body having a stable shape and strength adapted for a given application, and having a porosity allowing carrying PCM within its inner volume. The component typically has an open porosity, e.g. a foam or sponge-like internal pore structure capable of absorbing liquid. The component, upon filling with PCM in accordance with the present method, forms a TES component that can be incorporated in a composite material, to form a passive TES system. The component may generally consist of mineral material, but the use of metallic or synthetic materials may be considered for some applications.

In the context of building materials, for the production of cement or concrete composites, the component may be a porous construction aggregate, i.e. coarse particulate material, having some porosity and that is used in the preparation of cement or concrete mixture.

For example, the porous component or aggregate may have a particle size or diameter in the range of 1 to 30 mm, preferably 5 to 25 mm, more preferably 8 to 20 mm. The porosity may be of at least 40% in volume, preferably above 60% and more preferably above 75%. The strength is selected in relation with the desired application. For use in building materials, the porous component preferably has a compressive strength of at least 20 MPa, more preferably at least 30 MPa.

The present method has been particularly developed for the manufacture of TES aggregates from porous or lightweight aggregate, such as for example: diatomite, expanded perlite, expanded clay, expanded fly ash and vermiculite. The porous or light-weight aggregates may have a particulate size in the range of 2 to 20 mm, in particular 7 to 14 mm.

In particular, the present method allows manufacturing TES aggregates (TESA) that can be embedded by at least 20 vol. % in concrete, meaning 100-150 kg/m³ of PCM in a light-weight concrete of otherwise typical formulation. The compressive strength of light-weight concrete incorporating the present TESA is comparable to conventional light-weight concrete, i.e. in the range of 15 to 45 MPa.

The term phase change material (PCM) is used herein in its conventional sense, generally designating “latent” thermal storage materials possessing a large amount of heat energy stored during its phase change stage. The PCM for use in the present process may generally be solid-liquid PCMs, in particular selected from paraffins, fatty acids, and polyols. Preferably, the PCM is selected from the list comprising hexadecane, octadecane, Caprylic acid, Capric acid, Lauric acid and Glycerine, and their combinations. However, any appropriate PCM may be used, as well as combinations of PCMs.

The term “overpressure”, as used herein, conventionally means that the pressure in the main vessel is increased with respect to the initial loading pressure in the main vessel, i.e. the atmospheric pressure. The overpressure can be expressed relative to the initial atmospheric pressure (where the initial pressure is then zero—as can e.g. be read with a manometer having a scale in bar, often noted as gauge bar, bar g) or as absolute pressure. Preferably, the overpressure in the main vessel is controlled to have an absolute pressure of at least 2 bar, preferably at least 5 bar. The overpressure is typically established by the introducing gas in the main vessel, e.g. air or a neutral gas. In particular, the overpressure in the main vessel is in the range between 3 and 20 bar, more preferably between 8 and 12 bar (absolute pressure).

In practice, the pressure in the main vessel is controlled to establish the overpressure at the beginning of the injection step and the overpressure is maintained (uninterruptedly) until the end of the entrapment step.

The entrapment step is advantageously followed by a drainage step for removing excess phase change material. The drainage step may be carried out in any appropriate way, with the goal of separating the excess PCM from the PCM-filled components, either by extracting the components from the bed of viscous PCM or by purging the PCM from the vessel with the components still therein. The components could e.g. be placed in a basket that can be removed from the main vessel, after opening thereof, leaving a bed of PCM at the bottom of main vessel.

The purge of PCM is however preferred. In particular, the drainage preferably comprises allowing the main vessel to depressurize through a drainage orifice located in a lower region of the main vessel, to create a gaseous flow in between the pack of components contained in vessel. The flow of compressed gas/air will have a flushing effect, entraining the PCM in excess (remaining in the vessel, non-absorbed).

During the drainage step, the flushing can be repeated by re-pressuring and subsequently opening the main vessel. In particular, two flushing steps can be operated. A first flushing is achieved by opening the drainage orifice at the end of the entrapment stage, .i.e. starting from the corresponding overpressure. The air flow through the bed of components entrains liquid PCM out of the vessel and tends to cool the PCM on the outer surface of the components. The drainage orifice may then be closed again, compressed-gas introduced into the vessel to establish again an overpressure, and followed by opening the drainage orifice again to flush the vessel for the second time. The second flushing can be carried out with warmer compressed gas, while a temperature below the PCM melting point is reached for the PCM-filled components inside the vessel. The vessel is then flushed with warmer air to melt the external layers of PCM while PCM inside the material is at a temperature below the melting point.

After the drainage step, the PCM-filled components can be safely removed from the main vessel. Indeed, the PCM is solidified or has a very low viscosity, and thus remains entrapped in the pores of the porous components. They can thus be referred to as TES components.

For some applications, the thus obtained TES components can be readily mixed with other raw materials to form composite materials. This is particularly the case when the obtained TES component is to be mixed with cement or concrete mixtures, where cement will form an external barrier surrounding the TES components and thus block the pore openings at the surface of the component.

As it will be understood, cleaning of the porous components is of advantage to remove PCM from the outer surface of the porous components. Cleaning can be achieved during the drainage step. For example, in the above described flushing steps gas or air may be used as cleaning agent.

Alternatively, a separate cleaning step may be provided after the drainage step. A cleaning fluid can be used to rinse and clean the outer surface of the components. For example, the cleaning fluid may be water, or water combined with chemical cleanser.

Preferably, the method includes a sealing step for sealing the pores of the components filled with phase change material. This involves forming a coating on the outer surface of the component. In embodiments, the coating may be discontinuous and cover only the pores.

For mineral components, such as LWA, the coating may be formed by dipping the components into cement.

The first function of the sealing step is to avoid prevent the leakage of the PCM from within the LWA. But it is also desirable that the sealing layer acts as primer allowing, in the best possible manner, the bond with the cement paste to guarantee the concrete quality. Inorganic binders can advantageously be used for this purpose. Similarly to common cement, the alkali-activated inorganic polymers (also referred to as geopolymers) such as microsilica, metakaolin . . . react with alkaline solutions (e.g. calcium hydroxide) forming a cementitious material with high mechanical performance. The use of inorganic polymers is considered of advantage because, their setting is faster than

Portland cement, their structure is less porous and they exhibit a cleanser effect. It is thus possible to achieve a combined cleaning and sealing step by the use of alkali-activated inorganic polymers.

For increased fluidity during the injection step and preferably the impregnation step, the temperature is controlled to be in the melting temperature range of the PCM (i.e. in liquid state and below the boiling point), but higher than the melting point in such a way to increase the fluidity of the PCM without altering its properties.

During the entrapment step the temperature is reduced, while remaining in the melting temperature range, to a temperature close to the PCM melting temperature, in particular between 2 to 5° C. above the melting point. This will reduce the viscosity of the PCM in the pores of the porous components, and thus favour its entrapment therein.

These and other embodiments are recited in the appended dependent claims 2 to 18.

According to another aspect, the invention also concerns an apparatus for producing thermal energy storage components according to the present method, as recited in claim 19.

### BRIEF DESCRIPTION OF THE DRAWINGS

Further details and advantages of the present invention will be apparent from the following detailed description of not limiting embodiments with reference to the attached drawings, wherein:

FIG. 1: is a flowchart of one embodiment of the present method;

FIG. 2: is a diagram of an apparatus for implementing the present method; and

FIG. 3: is a graph illustrating the evolution of temperature and pressure in the main vessel vs time (temperature is measured in the centre of the main vessel).

### DETAILED DESCRIPTION OF PREFERRED EMBODIMENTS

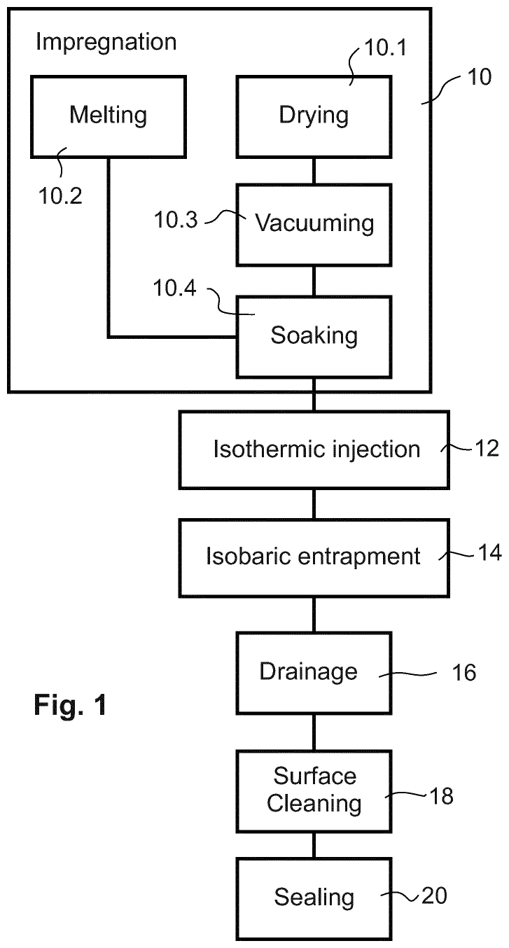

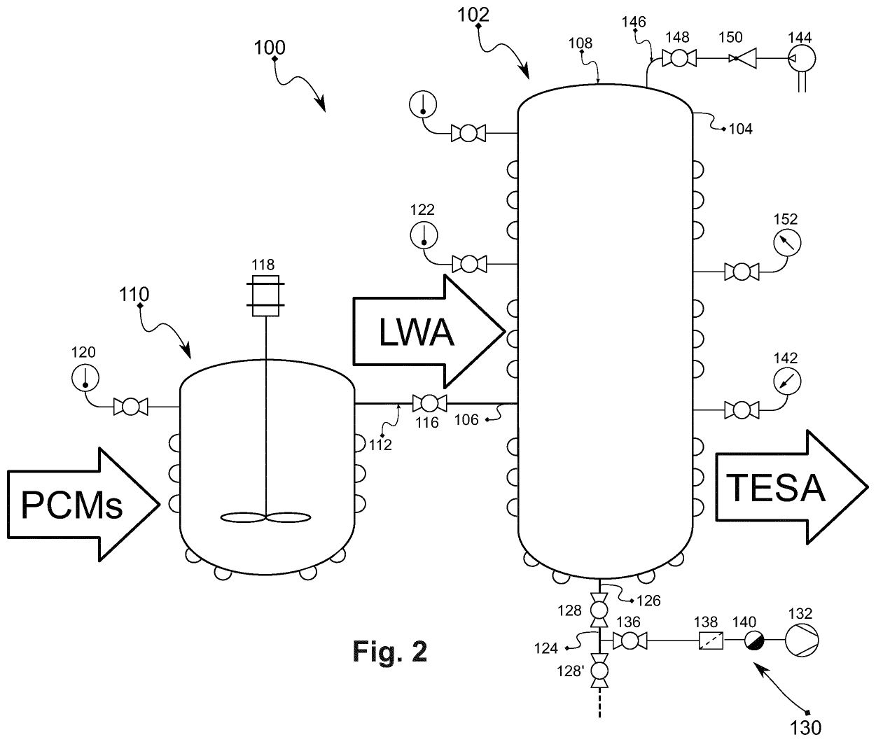

The present method will be described jointly with reference to FIGS. 1 and 2, in an embodiment concerning the production of PCM carrying porous or light-weight aggregates.

### 1. APPARATUS AND MATERIALS

As it will be understood, FIG. 2 is a principle drawing of an embodiment of an apparatus 100 for carrying out the present method, but it should not be construed as limiting. Those skilled in the art may devise other apparatuses as appropriate. Briefly, the apparatus 100 comprises a main vessel 102 comprising a material inlet 104 for porous aggregate and an inlet 106 for the PCM. Depending on the embodiment, the material inlet 102 can be designed as an orifice in the vessel's wall that can be sealed by a door. Alternatively, as is the case here, the inlet 102 may simply be an orifice that is closed by a removable wall portion of the vessel, here the upper end 108 of main vessel 102. The vessel construction is pressure resistant, adapted to operate under vacuum and above atmospheric pressure, i.e. under overpressure. Removal of the aggregates from the vessel 102 can be done through inlet 104 or alternatively through a dedicated orifice closed by a door, that may be arranged e.g. in the bottom region of the main vessel (not the case here). Reference sign 110 designates a secondary vessel that is used for melting the PCM, before introduction into the main vessel 102. A PCM duct 112 fluidly connects the secondary vessel outlet 110 to the PCM inlet 106 of the main vessel 102. The communication between both vessels can be opened or closed by way of a control valve 116.

In the embodiments described below as example, all the steps of the method are initiated manually by an operator. The skilled person will understand that the same steps may be initiated automatically using the appropriate control processor system.

For the manufacture of TES concrete, the porous aggregate is preferably expanded clay, or diatomite, expanded perlite or vermiculite.

Regarding the choice of PCM for building applications, the organic compounds are preferred as low temperature PCMs, because of their chemical stability, non-corrosive behaviour, reproducible melting and crystallization behaviour even after a high number of thermal cycles. Also, mixtures of PCM materials can be used to obtain a desired temperature of phase transition. Of particular interest here are paraffins, fatty acids and polyols.

Paraffins. Commercial paraffin waxes are an inexpensive raw material having a reasonable TES density: 120 up to 240 kJ/kg. Paraffins are available in a wide range of melting temperatures from approximately 20° C. up to about 70° C. In that range they are non-toxic, chemically inert, having a low vapour pressure in molten phase and do not undergo segregation, maintaining their performance after many thermal cycles.

Fatty Acids. Fatty Acids, which are Biobased PCMs, can be extracted from animal fat such as beef tallow and lard or from vegetal oils from plants as palms, coconuts, and soybeans. They are a renewable and green alternative to paraffinic PCMs. Since they are hydrogenated hydrocarbons with a saturated electronic configuration, they are chemically stable and can last for decades. In addition, Fatty Acids offer similar or improved performance than paraffins, such as greater fire resistance and lower carbon impact. Like paraffins, the melting temperatures can be adjusted selecting a right combination of eutectic binary admixtures.

Polyols/Glycerin. Polyols and the glycerin in particular are herein considered among the possible PCMs, since its thermal properties make this substance an excellent candidate to be used as TES in buildings, especially thanks to its price performance in recent years. In fact biodiesel production generates as the main byproduct about 10%—by weight—of glycerol.

Table 1 below summarize a number of preferred PCMs from the three above-mentioned families that are of particular interest in the context of the present method when applied to the production of TESA from LWA.

TABLE 1

| Phase-Change Material | | Melt. Point [° C.] | Latent heat [kJ/kg] |
|---|---|---|---|
| Hexadecane | C₁₆H₃₄ | 18.2 | 237 |
| Octadecane | C₁₈H₃₈ | 29 | 244 |
| Caprylic acid | C₈H₁₆O₂ | 16.7 | 149 |
| octanoic | | | |
| Capric acid | C₁₀H₂₀O₂ | 31.6 | 152 |
| decanoic | | | |
| Lauric acid | C₁₂H₂₄O₂ | 43.8 | 178 |
| dodecanoic | | | |
| Glycerin | C₃H₈O₃ | 17.9 | 199 |

### 2. DESCRIPTION OF AN EMBODIMENT OF THE PRESENT METHOD

### 2.1. Overview of the Method

In the present embodiment, the method can be summarized by the following sequence of steps (in this order), as also illustrated in FIG. 1:
vacuum impregnation 10: soaking of aggregates in liquid PCM under vacuum;
isothermal injection (box 12) of liquid PCM into the aggregates under overpressure;
isobaric entrapment (box 14) of the PCM: the temperature is reduced, to reduce fluidity, while maintaining the overpressure;
drainage (box 16): evacuation of excess PCM;
cleaning (box 18) of the PCM filled aggregates; and
sealing (box 20) of the pores of the aggregates.

It shall be appreciated that the combination of the injection and entrapment steps is remarkable in that they allow the incorporation of a substantial amount of PCM into the aggregates. The above steps will now be explained in more details herein below.

### 2.2. Vacuum Impregnation

Before starting the production, the aggregates to be treated are loaded into the main vessel 102 and the selected PCM material is loaded into the secondary vessel 110.

The impregnation step 10 begins with two preliminary steps where the lightweight aggregates and the phase change material are prepared to be mixed: a drying step 10.1 to remove humidity from the lightweight aggregates, and a melting step 10.2 to bring the phase change material to a liquid state of desired viscosity.

Melting step. The melting step 10.2 is carried out in the secondary vessel 110, which includes a heat exchanger (or radiator or other appropriate heating means—not shown), a mixing system 118 and a temperature gauge 120 for measuring the internal temperature. At the beginning of the melting step 10.2, the control valve 116 is in a closed state. Often, the PCM is in solid state when introduced into the secondary vessel 110; but it could as well be liquid, depending on the type of PCM.

During the melting step 10.2 the temperature inside the secondary vessel 110 is increased by way of the heat exchanger. The mixing system 118 is actuated to gently stir the PCM and distribute the temperature uniformly inside the PCM volume. The pressure inside the secondary vessel 110 is typically about the ambient pressure.

The first aim of the melting stage 10.2 is to bring the PCM to its melting temperature, which is dependent on the kind of PCM. Preferably, the temperature is further increased to a desired over-heating temperature, referred to as optimal over-heating level. The optimal over-heating level is in the melting range (i.e. above melting point but below boiling point) and is considered to be obtained when the PCM has reached a maximum fluidity without altering irreversibly the properties of the PCM. The optimal over-heating temperature is predetermined and depends on the type of material used. The melting step 10.2 is deemed to be completed when the temperature inside the PCM uniformly reaches the optimal over-heating temperature.

Drying step. The drying step 10.1 occurs in the main vessel 102, which comprises heating means (not shown) such as a heat exchanger (or heater or the like) configured to bring the main vessel 102 up to a predetermined drying temperature. The main vessel 102 also comprises an internal temperature gauge 122 to measure the temperature inside the vessel 102, namely in the centre of the vessel. Reference sign 124 designates a drain pipe that is connected to a drain orifice 126 in the lower part of the main vessel 102. The drain pipe 126 can be closed or opened by a pair of drain valves 128 and 128′. The drain orifice 126 and drain pipe 124 provide a path for allowing fluids to flow out of the main vessel 102.

During the drying step 10.1, the main vessel 102 is closed except for the drain valves 128 and 128′ which are open. The pressure in the main vessel is thus substantially equal to ambient pressure. The temperature inside the main vessel 102 is progressively raised up to the desired drying temperature, e.g. about 105° C. using the heat exchanger. Due to the heating, water potentially contained in the pores of the aggregates evaporates and exits the main vessel 102 through the drain duct 124. The drying step 10.1 may be implemented as a temperature ramp, in which case it is deemed complete when the temperature inside the vessel 102 reaches the desired temperature of 105° C. Other drying protocols may be used by those skilled in the art, as appropriate.

In practice, the drying step 10.1 and the melting step 10.2 may be performed in parallel (concurrently) in the respective vessels 102, 110.

At the end of the drying step 10.1, the drain valves 128, 128′ are closed in order to disconnect the main vessel 102 from the drain. Advantageously, the temperature inside the main vessel 102 is set (typically lowered—depending on PCM) to the optimal over-heating temperature of the PCM (i.e. similar to the melting temperature in the secondary vessel 110).

Vacuuming. At the end of the drying step 10.1, the drain pipe 124 is closed and the main vessel 102 thus closed in an air-tight manner. A vacuuming step 10.3 is then operated in order to evacuate air from the aggregates.

For this purpose a vacuuming unit 130 is connected to the main vessel 102 and comprises a vacuum pump 132 connected the drain pipe 124 via a vacuum duct comprising in series a valve 136, a dust trap 138 and a steam trap 140. The dust trap 138 and the steam trap 140 protect the vacuum pump 132 from steam and dust, and improve the functioning as well as the durability of the vacuum pump 132.

A vacuometer 142 is provided to measure the pressure inside the main vessel 102.

During the vacuuming step 10.3, drain valve 128 and the control valve 136 are open, allowing communication between the vacuum pump 132 and the main vessel 102. The vacuum pump 132 is energized and sucks air from the main vessel 102, thereby reducing the pressure therein. The vacuum level is set to remove water and air from the pores of the aggregates. Preferably the vacuum level is set to less than 100 mbar absolute pressure, in e.g. about 10 mbar. The duration of the vacuuming step 10.3 may be calibrated as appropriate. In general, the vacuuming step may be stopped when the desired vacuum level is reached.

During vacuuming, the temperature inside the main vessel 102 is preferably maintained at the optimal over-heating temperature of the PCM, in preparation for the following soaking step.

Soaking step. The aim of the soaking step 10.4 is to cause absorption of PCM into the aggregate particles. Indeed, air and water having been removed from the pores of the aggregates, liquid PCM may more easily enter the pores.

The soaking step 10.4 is preferably started directly after completion of the vacuuming step 10.3 (i.e. when the target vacuum level has been reached).

At the beginning of the soaking step 10.4, the control valve 116 on the PCM duct 112 is opened. The PCM contained in the secondary vessel 110 is sucked through pipe 112 into the main vessel 102, due to the depression in the main vessel. The amount of PCM in the secondary vessel 110 is preferably sufficient to saturate the main vessel 102. Once the PCM has been introduced in the main vessel 102, filing it completely, removing any air bubble, control valve 116 is closed. The introduction of the PCM causes a slight increase in pressure inside the main vessel 102, but it is still a low pressure, substantially under 1 bar (atmospheric pressure). At that moment the aggregates submerged by liquid PCM may thus absorb the PCM. The temperature inside the main vessel 102 is maintained at the optimal over-heating temperature of the PCM. At the end of the soaking step 10.4, valve 128 is closed.

During the soaking step 10.4, the porous LWA absorbs the PCM which is in its optimal viscosity state (optimal fluidity). The soaking step 10.4 concludes the impregnation step 10. The method then continues with the injection step 12 followed by the entrapment step 14.

### 2.3. Injection Step

In the injection step 12, an overpressure is established in the main vessel 102 to force liquid PCM material into the pores of the aggregates. This step is preferably carried out at the optimal over-heating temperature. In practice, the main vessel 102 is already at the optimal over-heating temperature at the start of the injection step.

In other embodiments, the temperature may be lower than the optimal over-heating temperature, but high enough to keep the PCM in a sufficient fluid liquid state.

The overpressure may be conveniently established by means of a compressor 144, namely an air compressor, connected to the main vessel 102 via a duct 146 with a compressor valve 148 and pressure reducing valve 150. The pressure reducing valve 150 allows for a fine pressure regulation inside the main vessel 105. A manometer 152 is provided to measure the pressure inside the main vessel 102.

At the end of the impregnation step 10, the pressure is low (sub-atmospheric). The compressor 144 is energized and the valve 148 is opened in order to establish the desired overpressure level inside the main vessel 102, i.e. a pressure above ambient/atmospheric pressure. Preferably, the overpressure may be of at least 4, more preferably at least 6 bar. In practice, the pressure may be in the range of 8 to 12 bar, e.g. about 10 bar (absolute). As it will be understood, the overpressure will allow further injection of the PCM into the aggregates, in particular by overcoming surface tension.

The desired injection pressure may be predetermined by calibration. The pressure is conveniently kept below pressures likely to irreversibly damage the aggregates.

The injection step may also be referred to as isothermal injection, since it is normally done at substantially constant temperature (preferably the over-heating temperature).

During the injection step 12, the level of liquid PCM inside the main vessel decreases. The injection step 12 may be deemed finished when the level of PCM inside the main vessel 102 has stabilized. At the end of the injection step 12, the compressor valve 148 is kept open, and both the pressure and the temperature are advantageously maintained at their level established during the injection step 12.

### 2.4. Entrapment Step

The entrapment step 14 begins with the above-mentioned conditions: the temperature inside the main vessel 102 is the optimal over-heating temperature of the PCM and the overpressure is at the desired level. The entrapment step 14 is carried out at the overpressure and is thus said to be “isobaric”.

During the entrapment step 14, the temperature is reduced from the optimal over-heating temperature to about the melting temperature of the PCM, in fact to a temperature slightly above the melting temperature, e.g. 2 to 5° C. In doing so, the viscosity of the PCM is lowered as the temperature drops towards the melting temperature. As a consequence, the fluidity of the PCM contained in the aggregates is significantly reduced, causing the entrapment of the PCM inside the pores of the aggregates.

A remarkable aspect of this step is that it is advantageously performed at constant overpressure, avoiding the outflow of PCM from the aggregates.

The drop of temperature is typically obtained by reducing the heat provided by the heating means. Since the main vessel 102 is closed, the cooling down may be relatively long (as compared to the length of the other steps). In embodiments, the temperature drop inside the main vessel may be accelerated by using appropriate cooling devices.

The entrapment step 14 may be considered to be completed once the temperature has uniformly reached the desired lower temperature of the PCM, just above melting point. At the end of the entrapments step 14, the PCM fluidity is thus significantly reduced, as compared to the injection step 12, however the PCM is not yet in solid state.

### 2.5. Drainage Step.

The aim of the drainage step 16 is to remove excess PCM and solidify the PCM in the aggregates. This is typically done by connecting the main vessel 102 to the atmosphere, e.g. by opening valves 128 and 128′. The flow of air, due to the outflow of compressed air, produces a flushing effect that entrains/removes PCM residing outside the aggregates.

Preferably, at least a first flushing is operated by opening the main vessel to the atmosphere from the overpressure residing in the main vessel at the end of the entrapment step. For some operating conditions, the first flushing may be sufficient. In addition to the entrainment of excess PCM, the flushing quickly reduces the temperature on their surface: the PCM rapidly solidifies, sealing the pores provisionally.

If desirable, such flushing can be repeated one or more times, as appropriate.

In particular, the first flushing may be followed by a second flushing.

For this purpose, after the first flushing, the vessel is closed and compressed air introduced via conduit 146 to establish again an overpressure, followed by opening the vessel to atmosphere (via drainage orifice 126) to cause the second flushing effect.

This may be desirable with some combinations of LWA and PCM, depending on the operating conditions. The first flushing typically occurs with somewhat “cold” compressed air when the temperature is slightly above the melting point, and removes the excess of PCM out of LWA grains while creating an outer layer of solid PCM. Sometimes, the heat stored into the grains, by the PCM, combined with the relative thermal insulation of the LWA, will be released soon after (due to thermal inertia), melting the solid layer. To address this situation, a second flushing is carried out after the first air-flushing, preferably rather soon, i.e. in less than 3 min. The vessel is thus closed, and the pressure increased to the isobaric-entrapment level [e.g. 10 bar], while the temperature for all the material contained in the vessel is allowed to drop to a stable temperature 2/5° C. below the melting point.

Then a second air-flushing is advantageously repeated using warmer air, and exploiting the same effect above mentioned: the air melts the external layer removing the excess PCM and the internal lower temperature solidifies the PCM, hence sealing the pores.

For this second flushing, the compressed air is preferably introduced at a temperature slightly above the melting temperature (a few degrees above). For this purpose, the apparatus 100 may include, on the compressed air duct 146, a device that allows controlling the temperature of the compressed gas (heating or cooling), e.g. a vortex tube or the like.

At this stage of the process, the PCM loaded LWA are already in the form of thermal energy storage aggregates also called TESA.

### 2.6. Surface Cleaning

TESA are preferably cleaned before an additional sealing step. The cleaning step 18 is a surface cleaning step for the TESA. The particles are cleaned of remaining traces of PCM solidified outside the aggregates.

The cleaning can e.g. be done using paper tissues. This can be carried out manually by an operator. However, the cleaning of the TESA may be done by any suitable means, and automatized.

Alternatively, a liquid cleaning agent may be used, e.g. water, optionally mixed with a cleanser.

### 2.7. Pore Sealing

The process ends with a pore sealing protocol 20, designed to avoid the leakage of PCM from the pores, when the temperature increases above the melting point. Any appropriate procedure that allows sealing the pores on the outer TESA surface may be used.

One way of sealing the pores is to form a coating or envelope on the outer surface of the TESA particles. For example, the PCM filled aggregates may be dipped in a slurry or grout of cement-based material. The reaction of calcium hydroxide will form a suitable outer layer on the TESA surface, appropriate for transport and storage.

Alternatively, pore sealing can be carried out by means of inorganic polymers. Similarly to common cement, the alkali-activated inorganic polymers (also referred to as geopolymers) such as microsilica, metakaolin . . . react with alkaline solutions (e.g. calcium hydroxide) forming a cementitious material with high mechanical performance. The use of inorganic polymers is considered of advantage because, their setting is faster than Portland cement, their structure is less porous and they exhibit a cleanser effect. It is thus possible to achieve a combined cleaning and sealing step by the use of alkali-activated inorganic polymers.

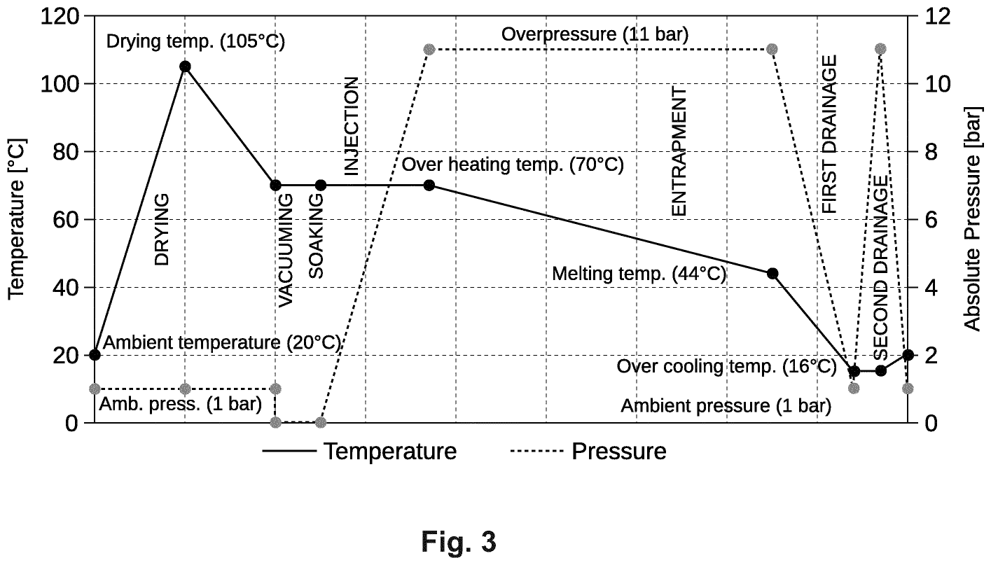

It may be noted here that the exemplary graph of FIG. 3 allows visualizing how the overpressure, once established during the injection step, is maintained until the end of the entrapment step. The two depressurizations can also be seen, corresponding to the first and second flushing. The temperature is measured at the center of the main vessel, at the hearth of the bed of components/LWA; is considered to reflect the PCM temperature.

It may be noted in passing that, in the example shown in FIG. 3, there is a waiting period between the end of the drying temperature ramp (reaching 105° C.) and the beginning of the vacuuming. This is due to the experimental set-up, which required a relatively long period of time to heat-up the PCM in the secondary vessel 110. This waiting period can be shorter, or even absent, i.e. vacuuming could start readily after the end of the drying stage.

### 3. EXAMPLES

### 3.1 Example 1. Preparation of TESA from Expanded Clay

In the following an example of production of TESA by way of the present method is described, starting from expanded clay as porous, lightweight aggregate. The method was carried in a laboratory-scale apparatus as described in relation to FIG. 2.

Commercially available expanded clay (product name “LECA” from Laterlite, Milano, Italy) was sieved to retain the 8-10 mm fraction. The main vessel was filled with 195.7 g of the sieved aggregate.

The aggregates had a porosity of about 85% and a compression strength of about 1 to 3 MPa.

The selected PCM was Lauric acid (dodecanoic acid, product W261408 from Sigma-Aldrich). The PCM was loaded in the secondary vessel.

Table 2 below summarizes for each of the above describe steps the operating temperatures and pressures, and the duration of the step.

TABLE 2

| Step | Temperature (° C.) | Pressure (bar) | Time (min) |
|---|---|---|---|
| Drying step | 105 | Ambient | 10 |
| Melting step | 70 | Ambient | 20 |
| Vacuuming step | 70 | 10 mbar (abs.) | <1 |
| Soaking step | 70 | >10 mbar (abs.) | 5 |
| Injection step | 70 | 11 (abs) | 12 |
| Entrapment | Down to 44 | 11 (abs) | 38 |
| step | | | |
| Drainage step | First flushing: | First flushing: | 10 |
| | Down to ambient | Down to ambient | |
| | Second flushing: | Second flushing: | 5 |
| | Up to X and down | Up to 11 bar and | |
| | to ambient | down to ambient | |

| | |
|---|---|
| Cleaning step | Manually operated |
| Pore sealing | Mixing TESA within concrete |
| step | |

At the end of the process, the total weight of aggregates had increased to 414.0 g. Hence, 218.3 g of PCM have been introduced in 785 cm³ of aggregate, i.e. TESA, which is equivalent to 278 kg/m³ of PCMs in concrete.

### 3.2. Example 2. Preparation of LWA Concrete

The TESA particles obtained at example 1 were used for manufacture LWA concrete. Table 3 summarized the constituents of the concrete mix.

TABLE 3

| Constituent | Dosage[kg/m³] |
|---|---|
| Cement | 146.34 |
| Water | 117.12 |
| Air Entraining Admixture (AEA) | 2.34 |
| Polypropylene Fibres | 3.08 |
| TESA: Light Weight Aggregate (LWA) [376 kg] and | 654 |
| Lauric Acid (PCM) [278 kg] | |

The obtained hardened LWA concrete sample with the TESA from example 1 was subjected to a compression test. The measured strength was comparable to that of a same sample of concrete with standard LWA, i.e. not filled with PCM. Hence the mechanical strength of the LWA concrete is not altered by the addition of PCMs to the LWA.

1. A method for producing thermal energy storage components comprising phase change material embedded into porous components, in particular for use in cement-based compositions, the method comprising:
an impregnation step comprising introducing phase change material into porous components inside a main vessel by vacuum impregnation;
characterized by an injection step at a temperature within a melting temperature range of said phase change material and under an overpressure, in order to force the phase change material into the porous components; and
an entrapment step comprising reducing the temperature inside the main vessel, while maintaining the overpressure, in order to lower the viscosity of said phase change material.

2. The method according to claim 1, wherein said impregnation step comprises:
vacuuming the main vessel containing the components, preferably after drying thereof;
introducing, under vacuum, liquid phase change material into the main vessel;
allowing the phase change material to soak in the components.

3. The method according to claim 1, wherein said overpressure in said main vessel is of at least 2 bar, preferably at least 5 bar, in particular said overpressure in said main vessel is in the range between 3 and 20 bar, more preferably between 8 and 12 bar.

4. The method according to claim 1, wherein said entrapment step follows said injection step; and said overpressure is maintained during the transition between both steps.

5. The method according to claim 1, wherein said entrapment step is followed by a drainage step for removing excess phase change material.

6. The method according to claim 5, wherein said drainage step comprises allowing said main vessel to depressurize through a drainage orifice located in a lower region of said main vessel, to create a gaseous flushing effect through said components, and preferably to reduce the temperature to below the melting temperature of said PCM.

7. The method according to claim 6, comprising one or more pressurizing/depressurizing cycles to provide additional flushing effects.

8. The method according to claim 1, further comprising a cleaning step, wherein the outer surface of the components filled with phase change material is cleaned.

9. The method according to claim 8, wherein said cleaning step includes subjecting the components filled with phase change material to a flow of cleaning fluid, in particular a flow of water or a flow of water mixed with a chemical cleanser.

10. The method according to claim 9, further comprising a sealing step for sealing the pores of the components filled with phase change material, preferably after cleaning.

11. The method according to claim 10, wherein the sealing step comprises the step of mixing the components in a cement paste.

12. The method according to claim 10, wherein the sealing step includes mixing the components with inorganic polymers, in particular with alkali-activated inorganic polymers.

13. The method according to claim 1, wherein said injection step and preferably said impregnation step, are a carried out at a temperature higher than a melting point of said PCM, but lower than a boiling point thereof, in order to increase fluidity of said liquid PCM.

14. The method according to claim 1, wherein during said entrapment step the temperature is reduced to a temperature close to the melting temperature of said PCM, in particular between 2 to 5° C. above said melting point.

15. The method according to claim 1, wherein said phase change material is selected from paraffins, fatty acids, and polyols.

16. The method according to claim 1, wherein said phase change material is selected from the list comprising hexadecane, octadecane, Caprylic acid, Capric acid, Lauric acid and Glycerine.

17. The method according to claim 1, wherein said porous component is a construction aggregate, in particular a porous or light-weight aggregate.

18. The method according to claim 17, wherein said aggregate is selected from the list comprising diatomite, expanded perlite, expanded clay, and vermiculite.

19. An apparatus for producing thermal energy storage components comprising:
a main vessel for receiving porous components and liquid phase change material, said main vessel comprising heating means and a compressor having a drain orifice in a lower part thereof;
a secondary vessel for heating up phase change material and connected with said main vessel via a duct;
a vacuuming unit connected to said main vessel;
overpressure means comprising a compressor connected to said main vessel in order to establish an overpressure in said main vessel.
